(19) United States
(12) Patent Application Publication
(10) Pub. No.: US 2007/0018790 A1
(43) Pub. Date: Jan. 25, 2007

(54) Touch-sensitive electronically controlled automotive door opener

(75) Inventor: Jay F. LaFrance, Plano, TX (US)

Correspondence Address: William J. Tucker, 14431 Gollad Dr., Box #8, Malakoff, TX, 75148, US

(73) Assignee: LaFrance Autoworks Inc.

(21) Appl. No.: 11/488,930

(22) Filed: Jul. 18, 2006

Related U.S. Application Data
(60) Provisional application No. 60/700,241, filed on Jul. 19, 2005.

(51) Int. Cl. B60R 25/00

(52) U.S. Cl. 340/5.72; 340/5.62; 340/426.24; 340/426.36

(57) ABSTRACT

An electronically controlled door opener is described herein which has a touch sensitive sensor that is located on an automobile and upon being touched by a person outputs a signal to a control circuit which causes a door actuator to activate and move a door latch which opens a door. Optionally, the electronically controlled door opener can incorporate another touch sensitive sensor which is located on the automobile and upon being rained-on prevents the first touch sensitive sensor from having a false trigger and inadvertently opening the door.

### CLAIMING BENEFIT OF PRIOR FILED APPLICATION

This application claims the benefit of U.S. Provisional Application Ser. No. 60/700,241 filed on Jul. 19, 2005 and entitled “Electronically Controlled Automotive Door Opener” which is incorporated by reference herein.

### BACKGROUND OF THE INVENTION

1. Field of the Invention

The present invention relates in general to the automotive field and, in particular, to an electronically controlled door opener which has a touch sensitive sensor that when touched by a person causes a door to pop open far enough so that the person can grab the edge of the door and finish opening the door. The electronically controlled door opener eliminates the need to have or use a door handle on the door.

2. Description of Related Art

For some people it can be very difficult and possibly painful for them to use a door handle to open a door on an automobile. For example, if a person suffers from arthritis or some other ailment then they could have trouble grabbing and pulling a door handle to open the door. Plus, some people who do not suffer from arthritis or other ailments may simply consider a door handle to be aesthetically unappealing. Thus, there are number of people who would consider it beneficial if the door handle could be eliminated all together and if there was another mechanism they could use to open a door. This need and other needs are satisfied by the electronically controlled door opener of the present invention.

### BRIEF DESCRIPTION OF THE INVENTION

An electronically controlled door opener is described herein which has a touch sensitive sensor that is located on an automobile and upon being touched by a person outputs a signal to a control circuit which causes a door actuator to activate and move a door latch which opens a door. Optionally, the electronically controlled door opener can incorporate another touch sensitive sensor which is located on the automobile and upon being rained-on prevents the first touch sensitive sensor from having a false trigger and inadvertently opening the door.

### BRIEF DESCRIPTION OF THE DRAWINGS

A more complete understanding of the present invention may be obtained by reference to the following detailed description when taken in conjunction with the accompanying drawings wherein:

FIG. 1 is a diagram of an automobile which has an electronically controlled door opener located thereon that is configured in accordance with the present invention;

FIGS. 2A-2D are four diagrams associated with a first embodiment of the electronically controlled door opener in accordance with the present invention;

FIG. 3 is a diagram associated with a second embodiment of the electronically controlled door opener in accordance with the present invention;

FIG. 4 is a flowchart that illustrates the steps of a method for installing the electronically controlled door opener onto the automobile in accordance with the present invention; and

FIG. 5 is a flowchart that illustrates the steps of a method for using the electronically controlled door opener to open a door located on the automobile in accordance with the present invention.

### DETAILED DESCRIPTION OF THE DRAWINGS

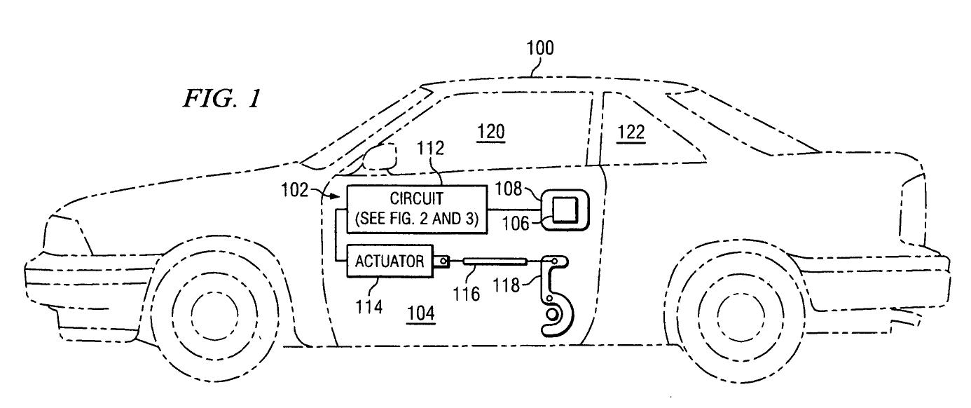

FIG. 1 is a diagram of an automobile 100 which has an electronically controlled door opener 102 located thereon that is configured in accordance with the present invention. Basically, the electronically controlled door opener 102 (located within the interior of the automobile 100) includes a touch sensitive sensor 106 (shown located behind an insert 108 placed where the door handle would normally have been located) which when touched by a person opens the door 104. In particular, the electronically controlled door opener 102 includes a touch sensitive sensor 106 which when touched by a person outputs a signal towards a control circuit 112 which activates a door actuator 114 (door solenoid 114) to move a cable/rod 116 which moves a door latch 118 that pops open the door 104 far enough so the person can grab the edge of the door 104 and finish opening the door 104. For clarity, the electronically controlled door opener 102 is described herein where it is used to open just one door 104 but it should be appreciated that the electronically controlled door opener 102 would typically have multiple touch sensitive sensors 106 which would be used to open multiple doors 104.

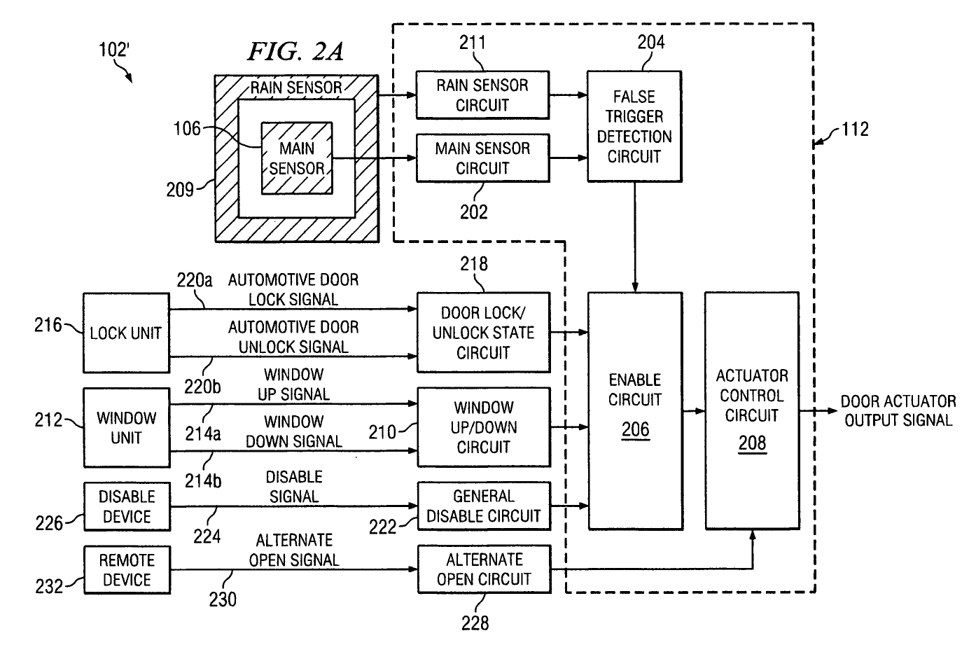

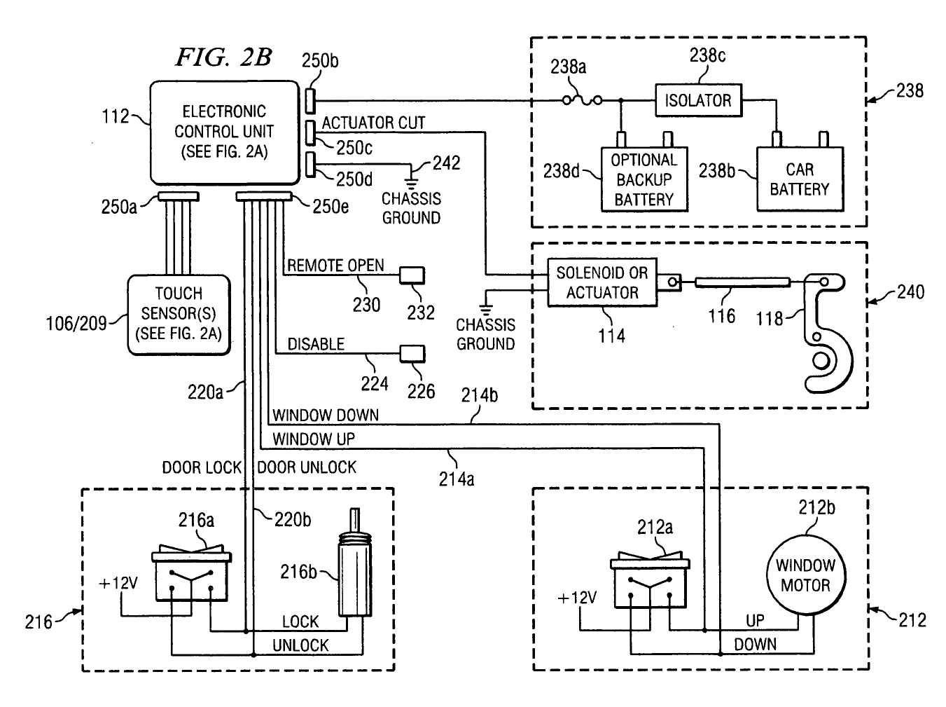

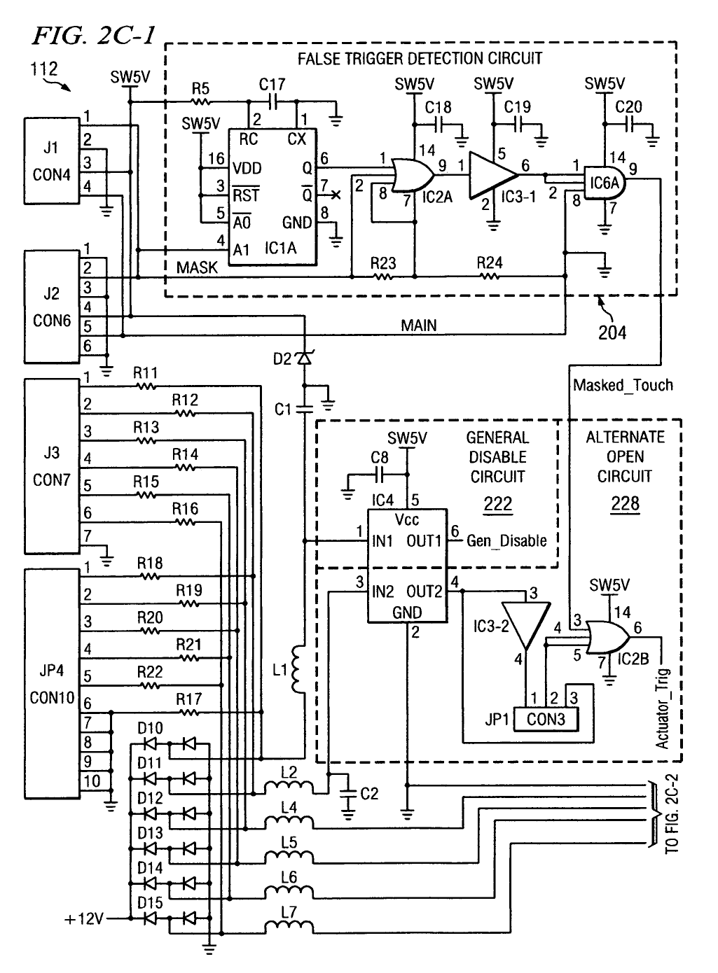

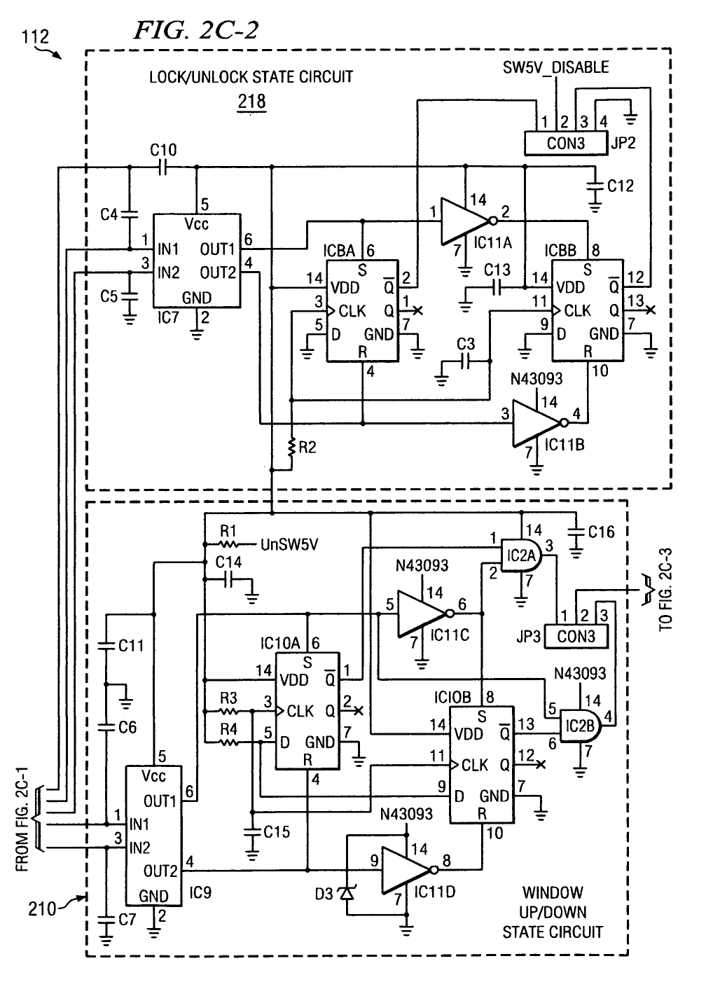

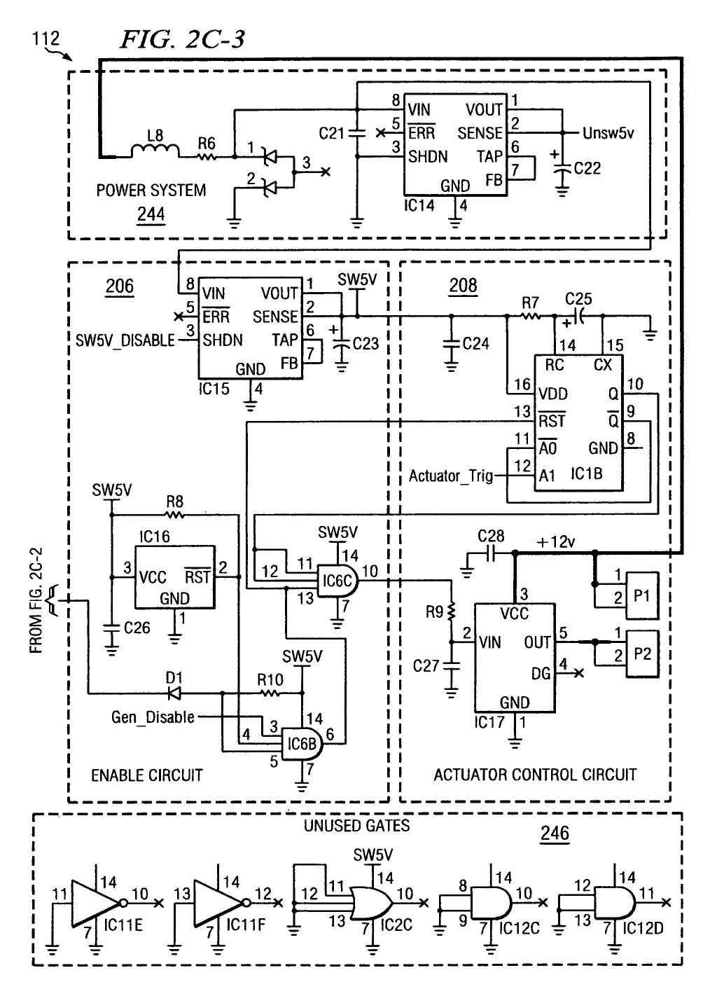

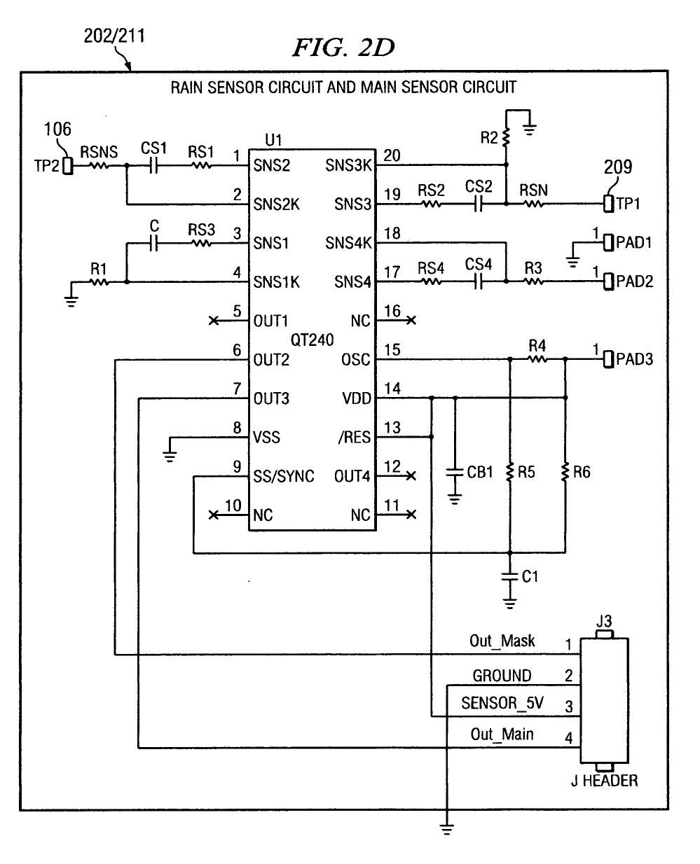

FIGS. 2A-2D are four diagrams which are used to help explain a first embodiment of the electronically controlled door opener 102′ in accordance with the present invention. In this embodiment, the electronically controlled door opener 102′ uses a touch sensitive sensor 106 as an electronic replacement for a factory installed mechanical door handle on the automobile 100. The touch sensitive sensor 106 can be placed on various locations of the automobile 100 including (for example): (1) behind the insert 108 (plastic door handle replacement 108) which is placed where the door handle would normally have been located (see FIG. 1); (2) on a movable window 120 located within the door 104 (see FIG. 1); or (3) on a fixed window 122 or on another non-conductive part of the automobile 100 (see FIG. 1).

In the first implementation, the touch sensitive sensor 106 is placed behind the plastic door handle replacement 108 which is flush with the surface of the door 106 and fits within the indention that is left after the factory door handle has been removed (see FIG. 1). The plastic door handle replacement 108 is designed to create a visually appealing appearance of a smooth surface along the entire surface of the door 106. Referring to FIG. 2A, when the outer surface of the plastic door handle replacement 108 is touched by a person, then the touch sensitive sensor 106 (main sensor 106) sends a signal to a main sensor circuit 202. The main sensor circuit 202 sends a signal to a false trigger detection circuit 204. The false trigger detection circuit 204 then sends a signal to an enable circuit 206. Thereafter, the enable circuit 206 sends a signal to an actuator control circuit 208 which sends a signal to the door actuator 114 which causes the door 104 to open far enough so the person can grab the edge of the door 104 and finish opening the door 104. Exemplary circuits 202, 204, 206 and 208 are shown in FIGS. 2C-2D.

In this implementation, the electronically controlled door opener 102′ can be susceptible to rain causing a short across the touch sensitive sensor 106 and the metal used to make the door 104 which would inadvertently open the door 104. To address this problem, the electronically controlled door opener 102′ could also include a second touch sensitive sensor 209 (rain sensor 209) which is used to distinguish between rain hitting the first touch sensitive sensor 106 and a person touching the first touch sensitive sensor 106. In particular, the second touch sensitive sensor 209 (shown surrounding the first touch sensitive sensor 106) can be added to act as a rain sensor which detects the rain before it hits the first touch sensitive sensor 106. If rain is present, then the second touch sensitive sensor 209 sends a signal to a rain sensor circuit 211 which interfaces with the false trigger detection circuit 204 that classifies a signal as being a false signal if one happens to be received at about the same time from the first touch sensitive sensor 106. But, if the first touch sensitive sensor 106 is touched first, as when someone places their hand on the plastic door handle replacement 108, then the first touch sensitive sensor 106 is activated first and this is considered a valid trigger which opens the door 102. In other words, the second touch sensitive sensor 209 only operates to prevent the opening of the door 104 for a split second as a rain drop rolls across the two touch sensitive sensors 106 and 209. Then, the first touch sensitive sensor 106 is immediately re-enabled so that the plastic door handle replacement 108 can be touched and the door 104 opened. This enables the person to open the door 104 while it is raining. If desired, the second touch sensitive sensor 209 can be used in the following two implementations. An exemplary rain sensor circuit 211 is shown in FIG. 2D.

In the second implementation, the touch sensitive sensor 106 is placed on the interior side of the movable glass window 120 which is located within the door 104 (see FIG. 1). In this case, the touch sensitive sensor 106 can be made from a clear conductive material which is virtually transparent. Referring to FIG. 2A, when the outer surface of the movable glass window 120 is touched by a person, then the touch sensitive sensor 106 (main sensor 106) sends a signal to a main sensor circuit 202. The main sensor circuit 202 sends a signal to a false trigger detection circuit 204. The false trigger detection circuit 204 then sends a signal to an enable circuit 206. Thereafter, the enable circuit 206 sends a signal to an actuator control circuit 208 which sends a signal to a door actuator 114 which causes the door 104 to open far enough so the person can grab the edge of the door 104 and finish opening the door 104. Exemplary circuits 202, 204, 206 and 208 are shown in FIGS. 2C-2D.

In this implementation, the movable touch sensitive sensor 106 is disabled by the enable circuit 206 when the window 120 is in the process of being rolled-down or has been rolled-down. At this time, the movable touch sensitive sensor 106 is not accessible to be touched by the person because it is located inside the door 104. The movable touch sensitive sensor 106 is re-enabled by the enable circuit 206 so it can be used to open the door 104 when the window 120 is rolled-up. To accomplish this, the enable circuit 206 interacts with a window up/down circuit 210 which receives a window-up signal 214a or a window-down signal 214b from a window motor control unit 212. If, the window up/down circuit 210 receives the window-up signal 214a then it outputs a signal to the enable circuit 206 which enables the movable touch sensitive sensor 106. In contrast, if the window up/down circuit 210 receives the window-down signal 214b then it outputs a signal to the enable circuit 206 which disables the movable touch sensitive sensor 106. An exemplary window up/down circuit 210 is shown in FIG. 2C.

In the third implementation, the touch sensitive sensor 106 is placed on the interior side of the fixed window 122 or is placed on some other non-conductive part of the automobile 100 (see FIG. 1). In this case, the touch sensitive sensor 106 can be made from a clear conductive material which is virtually transparent. Referring to FIG. 2A, when the outer surface of the fixed window 122 or the other non-conductive part of the automobile 100 is touched by a person, then the touch sensitive sensor 106 (main sensor 106) sends a signal to a main sensor circuit 202. The main sensor circuit 202 sends a signal to a false trigger detection circuit 204. Then, the false trigger detection circuit 204 sends a signal to an enable circuit 206. Thereafter, the enable circuit 206 sends a signal to an actuator control circuit 208 which sends a signal to a door actuator 114 which causes the door 104 to open far enough so the person can grab the edge of the door 104 and finish opening the door 104. Exemplary circuits 202, 204, 206 and 208 are shown in FIGS. 2C-2D.

In all of the implementations, the electronically controlled door opener 102′ could be interlocked with a door locking unit 216. If this happens, then the touch sensitive sensor 106 is enabled by the enable circuit 206 when the door locking unit 216 has been used to unlock the door 106. And, the touch sensitive sensor 106 is disabled by the enable circuit 206 when the door locking unit 216 has been used to lock the door 106. To accomplish this, the enable circuit 206 interacts with a door lock/unlock circuit 218 which receives a lock signal 220a or an unlock signal 220b from the door locking unit 216. If, the door lock/unlock circuit 218 receives the lock signal 214a then it outputs a signal to the enable circuit 206 which disables the touch sensitive sensor 106. As a result, when the person touches the touch sensitive sensor 106, then the electronically controlled door opener 102′ does not open the car door 104. In contrast, if the door lock/unlock circuit 218 receives the unlock signal 214b then it outputs a signal to the enable circuit 206 which enables the touch sensitive sensor 106. As a result, when the person touches the touch sensitive sensor 106, then the electronically controlled door opener 102′ opens the car door 104. An exemplary door lock/unlock circuit 218 is shown in FIG. 2C.

In all of the implementations, the electronically controlled door opener 102′ could also have a general disable circuit 222 which upon receiving a disable signal 224 causes the enable circuit 206 to disable the touch sensitive sensor 106 so it cannot be used to open the door 104. The disable signal 224 can be sent by disable device(s) 226 such as (for example): (1) a toggle switch 226a; (2) a motion switch 226b that disables the touch sensitive sensor 106 when the automobile 100 is in motion; (3) a transmission neutral switch 226c that disables the touch sensitive sensor 106 when the automobile 100 is not in park or neutral; and (4) a rain sensor 226d that disables the touch sensitive sensor 106 when it detects rain (compare to rain sensor 209). An exemplary disable circuit 222 is shown in FIG. 2C.

Moreover, the electronically controlled door opener 102′ could have an alternate open circuit 228 which upon receiving an open signal 230 causes the enable circuit 206 to bypass the touch sensitive sensor 106 and open the door 104. For instance, the alternate open circuit 228 could be tied into a remote system which allows a person to use a remote control device 232 (e.g., alarm remote key 232) to bypass the touch sensitive sensor 106 and open the door 104. An exemplary alternate open circuit 228 is shown in FIG. 2C.

FIGS. 2B-2D are diagrams which illustrate one exemplary way that could be used to implement the first embodiment of the electronically controlled door opener 102′ in accordance with the present invention. In FIG. 2B, there is shown a connection diagram which illustrates how the electronically controlled door opener 102′ can be interfaced with existing components located within the automobile 100. In particular, the two touch sensitive sensors 106 and 209 interface with the circuit 112 via wire connector 250a (see FIG. 2A). In one embodiment, the two touch sensitive sensors 106 and 209 can be a QT240 QTouch™ Touch Sensor which has two self-contained digital sensors that are capable of detecting a direct touch or a near-proximity touch. In addition, the circuit 112 interfaces with a power unit 238 (including a fuse 238a, a battery 238b, an isolator 238c and an optional backup battery 238d) via a wire connector 250b. The circuit 112 interfaces with a door opening mechanism 240 (including the door actuator 114, the cable/rod 116 and the door latch 118) via a wire connector 250c. The circuit 112 interfaces with a chassis ground 242 via a wire connector 250d. The circuit 112 also interfaces with the remote control device 232 and the disable device(s) 226 via a wire connector 250e. In addition, the circuit 112 interfaces with the window motor control unit 212 (including a switch 212a and a window motor 212b) and the door locking unit 216 (including a switch 216a and a locking actuator 216b) via the wire connector 250e.

In FIGS. 2C-2D, there is shown a schematic which illustrates one way how the circuit 112 could be designed using specific electrical/electronic components. The schematic illustrates the various electrical/electronic components which could be used to make the following circuits: (1) the main sensor circuit 202 and the rain sensor circuit 211; (2) the false trigger detection circuit 204; (3) the enable circuit 206; (4) the actuator control circuit 208; (5) the window up/down circuit 210; (6) the door lock/unlock circuit 218; (7) the general disable circuit 222; and (8) the alternate open circuit 228. In addition, the schematic shows a power system 244 and a set of unused gates 246 which are part of this exemplary circuit 112. The specific integrated chips (ICs) identified in the schematic are as follows:

TABLE 1

| Designator | Mfg Part ID | Description |
|---|---|---|
| IC1 | QT240-IS | Touch Sensor IC |
| | | Dual Precision Monostable |
| IC1 | MC14538BD | Multivibrator |
| IC2 | CD4075BM | Triple 3 input OR Gate |
| IC3 | SN74LVC2G04 | Dual Inverter |
| IC4 | MAX6817 | Dual CMOS Switch Debouncer |
| IC6 | CD4073BM | Triple 3 input AND |
| IC7 | MAX6817 | Dual CMOS Switch Debouncer |
| IC8 | CD4013BM | Dual D-Flip Flop |
| IC9 | MAX6817 | Dual CMOS Switch Debouncer |
| IC10 | CD4013BM | Dual D-Flip Flop |
| IC11 | CD4069UBM | Hex Inverter |
| IC12 | CD4081BM | Quad 2 input AND |
| IC13 | MMBZ20VAL | Transient Voltage Suppressor-20 V |
| | MIC2951-03YM | 5 V Regulator-very low quiescent |
| IC14 | TR | current |
| | MIC2951-03YM | 5 V Regulator-very low quiescent |
| IC15 | TR | current |
| IC16 | LM809M3-4.63 | Microprocessor Reset, 5 V |
| IC17 | IPS5451S | Intelligent Switch, 35 A max |

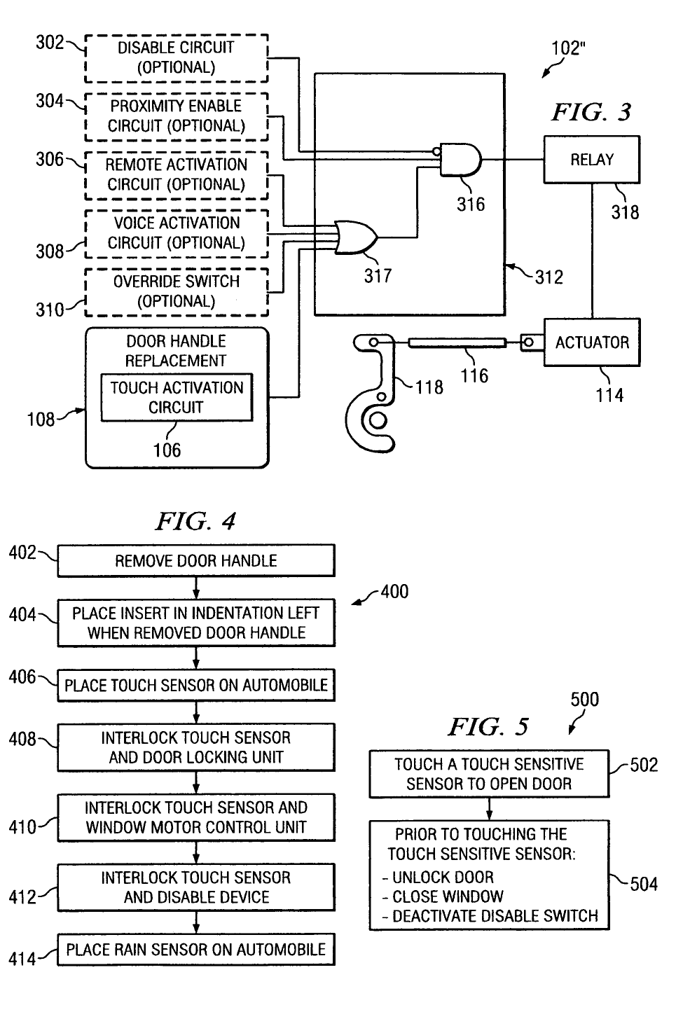

FIG. 3 is a diagram which is used to help explain a second embodiment of the electronically controlled door opener 102″ in accordance with the present invention. The electronically controlled door opener 102″ has a touch sensitive sensor 106 shown located within the plastic door handle replacement 108 (see FIG. 1—if desired the rain sensor 209 could be used as well in this embodiment). In addition, the electronically controlled door opener 102″ can have one or more of the following optional circuits/switches: (1) disable circuit 302 (which prevents the activation and release of the door latch 118); (2) proximity enable circuit 304 (which allows the other activation methods to operate when a holder of a particular remote device (e.g., radio frequency identification device (RFID)) is located within a pre-defined distance from the automobile 100); (3) remote activation circuit 306 (which is used to generate a signal to release the door latch 118); (4) voice activation circuit 308 (which recognizes key words and releases the door latch 118); and (5) override switch 310 (which is used in the event there is a failure with only one of the circuits/switches 106, 306 and 308). The switches/circuits 106, 302, 304, 306, 308 and 310 interface with an electronic circuit board 312. In this example, the electronic circuit board 312 has an OR gate 314 and an AND gate 316 which together function to close a relay 318 when anyone of the switches/circuits 106, 306, 308 and 310 is activated and if the proximity enable circuit 304 is active and the disable circuit 302 is not active. The closing of the relay 318 causes the door actuator 114 to move a cable/rod 116 which moves the door latch 118 that pops open the door 104 far enough so the person can grab the edge of the door 104 and finish opening the door 104. Note: the various features in this embodiment could be used in the first embodiment of the electronically controlled door opener 102′ and vice-versa.

FIG. 4 is a flowchart that illustrates the steps of a method 400 for installing the electronically controlled door opener 102 onto the automobile 100 in accordance with the present invention. Beginning at step 402, the door handle is removed from the door 104. At step 404, the insert 108 (plastic door handle replacement 108) is placed within the indentation which was left after removing the door handle from the door 104′. At step 406, the first touch sensitive sensor 106 (main sensor 106) is placed on the automobile 100 such that when a person touches the first touch sensitive sensor 106 a signal is outputted therefrom and received by the circuit 112 which causes the door actuator 114 to activate and move the door latch 118 which in turn opens the door 104. At step 408, the first touch sensitive sensor 106 is interlocked with the door locking unit 216 such that if the door 104 is locked then the first touch sensitive sensor 106 is disabled which prevents the person from opening of the door 104.

The touch sensitive sensor 106 can be placed on various locations of the automobile 100 including (for example): (1) behind the insert 108 (plastic door handle replacement 108) which is placed where the door handle would normally have been located (see FIG. 1); (2) on the movable window 120 located within the door 104 (see FIG. 1); or (3) on the fixed window 122 or another non-conductive part of the automobile 100 (see FIG. 1). If the first touch sensitive sensor 106 is placed on the movable window 120, then the first touch sensitive sensor 106 can be interlocked with the window motor control unit 212 such that if the window 120 is opened or is in a process of being opened then the first touch sensitive sensor 106 can not be used by the person to open the door 104 (see step 410).

At step 412, the disable device(s) 226 can be placed on the automobile 100 such that if the disable device(s) 226 is activated then the first touch sensitive sensor 106 can not be used by the person to open the door 104. The disable device(s) 226 includes (for example): (1) the toggle switch 226a; (2) the motion switch 226b that disables the first touch sensitive sensor 106 when the automobile 100 is in motion; (3) the transmission neutral switch 226c that disables the first touch sensitive sensor 106 when the automobile 100 is not in park or neutral; and (4) the rain sensor 226d that disables the first touch sensitive sensor 106 when it detects rain (compare to the second touch sensitive sensor 209).

At step 414, the second touch sensitive sensor 209 (rain sensor 209) can be placed on the automobile 100 such that when the second touch sensitive sensor 209 is rained-on it prevents the first touch sensitive sensor 106 from being used to open the door 104. The rain sensor 209 is used to address the problem where rain can cause a short across the first touch sensitive sensor 106 and the metal used to make the door 104 and inadvertently open the door 104. Note: the rain sensor 209 if used can be placed on the automobile 100 at the same time as the main sensor 106 because both sensors 106 and 209 could be part of the same device like the aforementioned QT240 QTouch™ Touch Sensor.

FIG. 5 is a flowchart that illustrates the steps of a method 500 for using the electronically controlled door opener 102 to open a door 104 located on an automobile 100 in accordance with the present invention. At step 502, the person touches or waives their hand in front of the first touch sensitive sensor 106 which has been placed on the automobile 100. After being touched, the first touch sensitive sensor 106 outputs a signal that is received by circuit 112 which then causes the door actuator 114 to activate and move the door latch 118 which in turn causes the door 104 to pop open far enough so the person can grab the edge of the door 104 and finish opening the door 104. At step 504, the person prior to touching the first touch sensitive sensor 106 may have to: (1) unlock the door 104; (2) close the movable window 120 (if the first touch sensitive sensor 106 is attached to movable window 120); and (3) disable the disable device(s) 226.

From the foregoing, it should be appreciated that the electronically controlled door opener 102 is an electronic replacement for the factory installed mechanical door handle on an automobile 100. The electronically controlled door opener 102 includes the touch sensitive sensor 106 which when touched by a person outputs a signal towards the control circuit 112 which then activates the door actuator 114 which moves the cable/rod 116 which moves the door latch 118 that pops open the door 104 far enough so the person can grab the edge of the door 104 and finish opening the door 104. The electronically controlled door opener 102 has many desirable features/advantages some of which have been listed below:

The automobile 100 can have a smooth door look without needing to have expensive body work and painting performed.

The electronically controlled door opener 102 enables the trick effect of opening a door with just the touch of a finger/hand.

The electronically controlled door opener 102 is easy to install on the automobile 100.

The electronically controlled door opener 102 works well with the existing keyless entry system. For instance, assume there are multiple touch sensitive sensors 106 and each works in conjunction with a corresponding door 104 on the automobile 100. If the person pushes the button on their keyless entry system and unlocks only the driver's door, then only the driver's door touch sensitive sensor 106 is enabled so it can be used to open the driver's door 104.

While particular embodiments of the invention have been described, it will be understood, however, that the present invention is not limited thereto, since modifications may be made by those skilled in the art, particularly in light of the foregoing teachings. It is, therefore, contemplated by the appended claims to cover any such modifications that incorporate those features or those improvements which embody the spirit and scope of the present invention.

One such alternate embodiment contemplated by the present invention is to use touch sensitive sensors throughout the automobile for applications such as, but not limited to, a suspension control system, a lighting system, a climate control system, a security system, a navigation system, and a audio/video system. Each of these applications are discussed below:

1. The touch sensitive sensor(s) can be used to control the suspension control system (SCS). In particular, the touch sensitive sensor(s) can be used to raise/lower the individual tire suspensions by adding or releasing air into or out of the suspension system. The touch sensitive sensor(s) can also be used to increase or decrease the firmness of the suspension for each of the four tires. This is desirable because the touch sensitive sensors respond quicker than mechanical switches and they provide a more appealing appearance for the interior of the automobile because they are flat with the surface of the vehicle's interior surfaces such as the dash board.

2. The touch sensitive sensor(s) can be used to control the interior and exterior lights on an automobile 100 such as dome lights, reading lights, and accent lights.

3. The touch sensitive sensor(s) can be used for climate control. For instance, the touch sensitive sensor(s) can be used to control fan speed, temperature, and other climate devices in the automobile 100.

4. The touch sensitive sensor(s) can be used inside or outside of the automobile 100 to set security options such as arm, disarm, panic, lock and unlock.

5. The touch sensitive sensor(s) can be used to set or program a navigation control system. For instance, the touch sensitive sensor(s) can be used to input a feature selection, next, previous, enter etc . . . into the navigation control system.

6. The touch sensitive sensor(s) can be used to control an audio/video system (e.g., stereo, DVD player) within the automobile 100. For instance, the touch sensitive sensor(s) can be used to control the volume, channel, base, treble, balance, fade, and many other functions associated with the audio/video system.

What is claimed is:

1. An automotive door opener comprising a first touch sensitive sensor which is located on an automobile and which upon being touched by a person activates and outputs a signal to a control circuit which causes a door actuator to activate and move a door latch which in turn opens a door located on said automobile.

2. The automotive door opener of claim 1, further comprising a second touch sensitive sensor which is located on said automobile and which upon being rained-on prevents said first touch sensitive sensor from being used to open said door.

3. The automotive door opener of claim 1, wherein if said door is locked then said first touch sensitive sensor can not be used by said person to open said door.

4. The automotive door opener of claim 1, wherein said first touch sensitive sensor is placed behind a non-conductive insert which is located where a door handle used to be located on said door.

5. The automotive door opener of claim 1, wherein said first touch sensitive sensor is placed on a window and if said window is opened or is in a process of being opened then said first touch sensitive sensor can not be used by said person to open said door.

6. The automotive door opener of claim 1, further comprising a disable device which is located on said automobile and which upon being activated prevents said first touch sensitive sensor from being used by said person to open said door.

7. The automotive door opener of claim 6, wherein said disable device further includes:
a toggle switch;
a motion switch;
a rain sensor; and/or
a switch which disables said first touch sensitive sensor when said automobile is not in park or neutral.

8. A method for installing an electronically controlled door opener onto an automobile, said method comprising the steps of:
removing a door handle from a door located on said automobile;
placing a non-conductive insert into an indentation which was left within said door after removing said door handle; and
placing a first touch sensitive sensor on said automobile such that when a person touches said first touch sensitive sensor a signal is outputted therefrom and received by a control circuit which causes a door actuator to activate and move a door latch which in turn opens said door.

9. The method of claim 8, further comprising the step of placing a second touch sensitive sensor on said automobile, wherein when said second touch sensitive sensor is being rained-on then said first touch sensitive sensor can not be used to open said door.

10. The method of claim 8, further comprising the step of interlocking said first touch sensitive sensor and a door lock such that if said door is locked then said first touch sensitive sensor can not be used by said person to open said door.

11. The method of claim 8, wherein said step of placing said first touch sensitive sensor on said automobile further includes:
placing said first touch sensitive sensor behind the non-conductive insert which is located where the door handle used to be located on said automobile;
placing said first touch sensitive sensor on a movable window located on said automobile; or
placing said first touch sensitive sensor on a fixed window or a non-conductive part of said automobile.

12. The method of claim 11, wherein if said first touch sensitive sensor is placed on said movable window then said first touch sensitive sensor is interlocked with a window motor control unit such that if said window is opened or is in a process of being opened then said first touch sensitive sensor can not be used by said person to open said door.

13. The method of claim 8, further comprising the step of placing a disable device on said automobile such that if said disable device is activated then said first touch sensitive sensor can not be used by said person to open said door.

14. The method of claim 13, wherein said disable device further includes:
a toggle switch;
a motion switch;
a rain sensor; and/or
a switch which disables said first touch sensitive sensor when said automobile is not in park or neutral.

15. A method for opening a door located on an automobile, said method comprising the step of:
touching a touch sensitive sensor which is located on said automobile where said first touch sensitive sensor after being touched activates and outputs a signal to a control circuit which causes a door actuator to activate and move a door latch which in turn opens a door located on said automobile.

16. The method of claim 15, further comprising a step of unlocking the door prior to touching said touch sensitive sensor.

17. The method of claim 15, further comprising a step of closing a movable window prior to touching said touch sensitive sensor.

18. The method of claim 15, further comprising the step of disabling a disable device prior to touching said touch sensitive sensor, wherein said disable device includes:
a toggle switch;
a motion switch;
a rain sensor; and/or
a switch which disables said first touch sensitive sensor when said automobile is not in park or neutral.

19. A mechanism for activating a door latch to open a door on an automobile which no longer has a door handle to activate the door latch to open the door on the automobile, wherein said mechanism includes:
a touch sensitive sensor;
a remote actuating device;
a voice recognition device;
a fingerprint identification device;
a hidden override device; and/or
a proximity enable device.

20. A touch sensitive sensor used within an automobile to enable a person to interact with and control one of the following systems:
an electronically controlled door opener;
a suspension control system;
a lighting system;
a climate control system;
a security system;
a navigation system; or
an audio/video system.
